(19) United States
(12) Patent Application Publication
(10) Pub. No.: US 2011/0087992 A1
(43) Pub. Date: Apr. 14, 2011

(54) THUMBNAIL IMAGE SUBSTITUTION

(75) Inventors: Xuanran Wang, Beijing (CN); Ron Dun, Beijing (CN); Yong Zhao, Beijing (CN)

(73) Assignee: MICROSOFT CORPORATION, Redmond, WA (US)

(21) Appl. No.: 12/578,493

(22) Filed: Oct. 13, 2009

(51) Int. Cl. G06F 3/048

(52) U.S. Cl. 715/784; 715/800

(57) ABSTRACT

Thumbnail image substitution is described. In embodiments, a navigation input is received that is effective to move from a first view of a media content page to a second view of the media content page. The second view includes a region of the media content page that is not included in the first view of the media content page. A thumbnail image is displayed in the region of the media content page that is not included in the first view and that will display the media content. The thumbnail image is replaced to display the media content in the region of the media content page that corresponds to the second view of the media content page.

### BACKGROUND

Portable devices are increasingly more common and mobile, such as laptop computers, tablet PCs, ultra-mobile PCs, as well as other mobile data, messaging, and/or communication devices. When a user holds a small, portable device such as a tablet PC or ultra-mobile PC that has an integrated touch-screen, a common interaction technique is to hold the device with one hand and interact with the touch-screen with the other hand. For example, users can tap-touch targets, user interface elements, selectable icons, or menu items on a touch-screen, as well as gesture to view regions of a Web page that are out of view on a small display screen.

While portable devices have become more mobile and convenient, the size of device integrated displays has decreased to accommodate the mobility and convenience of the devices. Moreover, due to memory limitations, small portable devices may not be able to render the contents (e.g., HTML code, images, scripts, etc.) of an entire Web page, document, or other media content for viewing. As a result, regions of a Web page that are out of view on a small display screen may not be stored in memory on a device. A technique utilized to fill in these regions during Web page navigation is to temporarily display a grey or checkerboard background in place of the media content that will be displayed in a region. However, utilizing such techniques can result in a non-intuitive navigation experience for a user trying to access those regions of media content that are out of view on a small display screen.

### SUMMARY

This summary is provided to introduce simplified concepts of thumbnail image substitution that are further described below in the Detailed Description. This summary is not intended to identify essential features of the claimed subject matter, nor is it intended for use in determining the scope of the claimed subject matter.

Thumbnail image substitution is described. In embodiments, a navigation input is received that is effective to move from a first view of a media content page to a second view of the media content page. A media content page can include an image of a Web page, an email, a document, a spreadsheet, or any other media content. The second view includes a region of the media content page that is not included in the first view of the media content page. A thumbnail image is displayed in the region of the media content page that is not included in the first view and that will display the media content. The thumbnail image provides an indication of the media content that will be displayed in the region of the media content page that corresponds to the second view of the media content page. The thumbnail image is then replaced to display the media content in the region of the media content page that corresponds to the second view of the media content page. Replacing the media content with the thumbnail image can be animated to give the appearance that the thumbnail image comes into focus when the media content is displayed clearly.

### BRIEF DESCRIPTION OF THE DRAWINGS

Embodiments of thumbnail image substitution are described with reference to the following drawings. The same numbers are used throughout the drawings to reference like features and components:

FIG. 1 illustrates an example of a portable device that can implement various embodiments of thumbnail image substitution.

FIG. 2 illustrates an example system in which embodiments of thumbnail image substitution can be implemented.

FIG. 3 illustrates example method(s) of thumbnail image substitution in accordance with one or more embodiments.

FIG. 4 illustrates various components of an example device that can implement embodiments of thumbnail image substitution.

### DETAILED DESCRIPTION

Embodiments of thumbnail image substitution provide techniques for a user of a portable device to intuitively navigate and view a page of media content when the media content page is larger than can be displayed on a display screen of the portable device. For example, the user can initiate a touch input on a touch-screen and then motion a navigation gesture across the touch-screen. When the motion of the navigation gesture is initiated by the user, a progression of the motion as the touch input remains in contact with the touch-screen creates a contact region on the touch-screen that progressively expands and is detected. The progressive expansion of the contact region on the touch-screen is then determined or recognized as the navigation input that is effective to move from a first view of a media content page to a second view of the media content page.

While a region of the media content in the second view that is not displayed in the first view is received, loaded, and/or generated to be displayed in the second view, a thumbnail image is displayed as a substitute for that media content. Unlike a checkerboard or grey background, the thumbnail image provides an indication of the media content that will be displayed for a portion of the media content page. When the media content is received, loaded, and/or generated, it replaces the thumbnail image and may be animated so that the thumbnail image appears to come into focus when the media content is displayed.

While features and concepts of the described systems and methods for thumbnail image substitution can be implemented in any number of different environments, systems, and/or various configurations, embodiments of thumbnail image substitution are described in the context of the following example systems and environments.

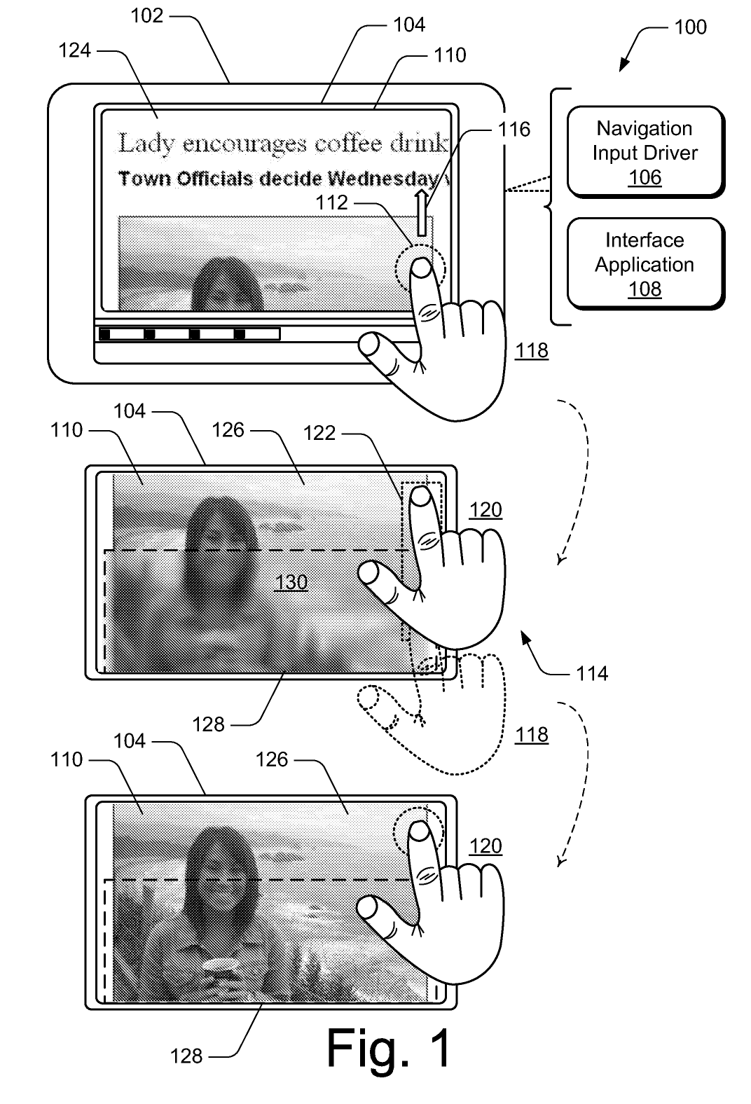

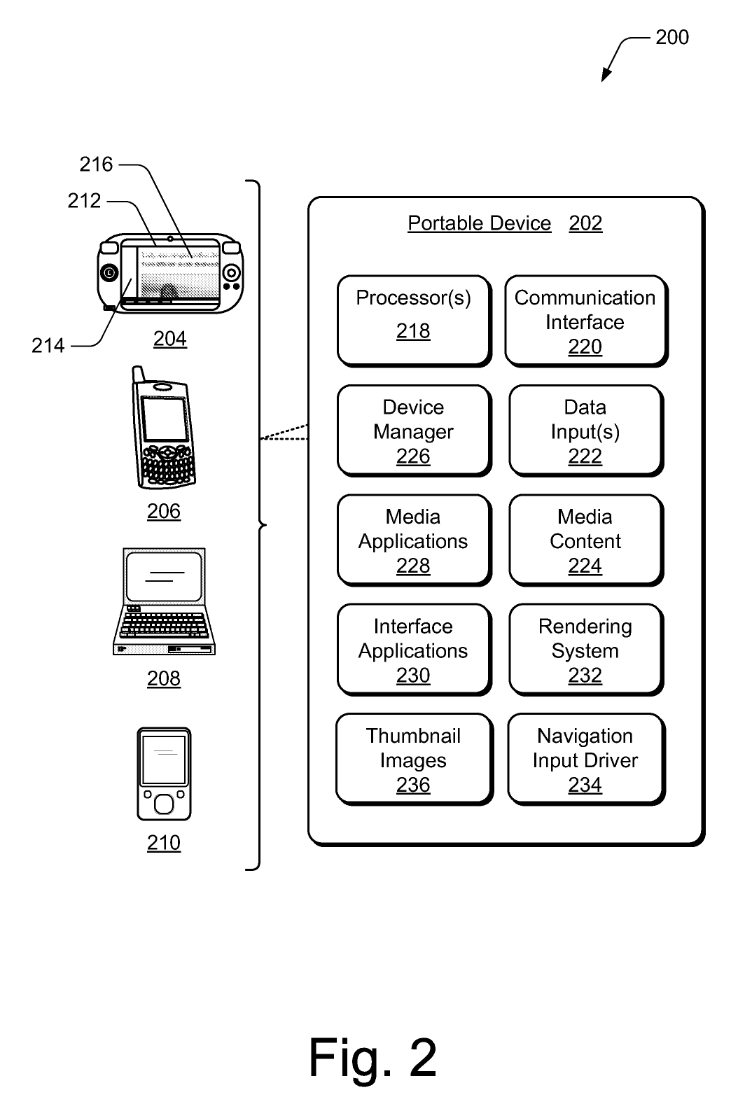

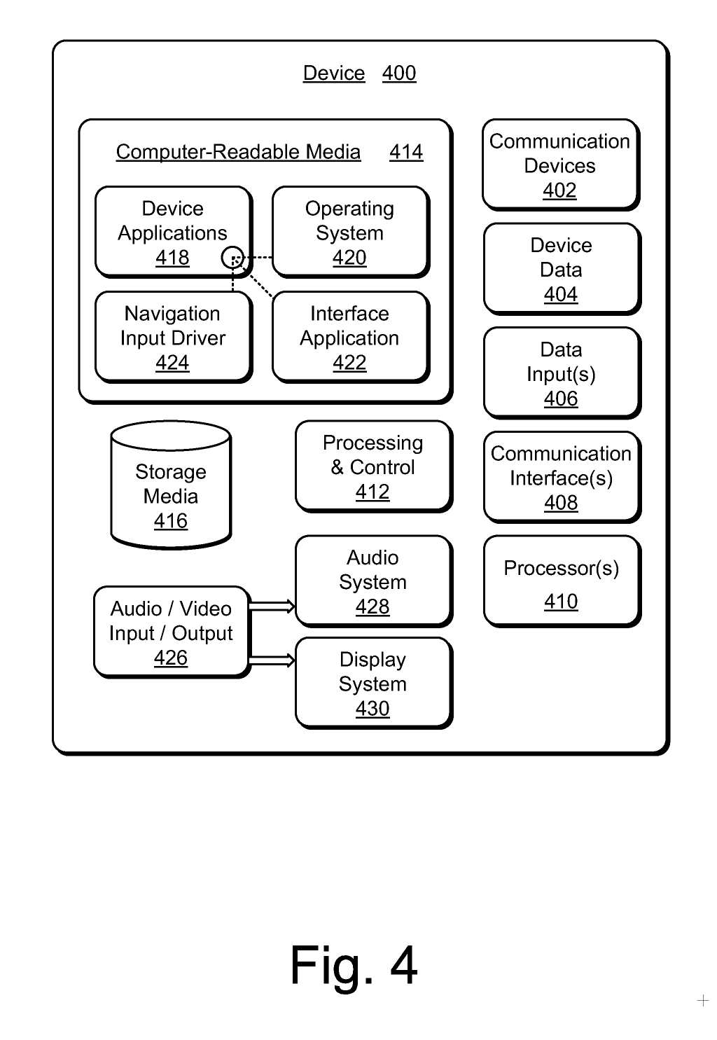

FIG. 1 illustrates an example 100 of a portable device 102 that can implement various embodiments of thumbnail image substitution. Portable device 102 is an example of any of the various types of portable devices described with reference to FIG. 2 and can also be implemented with any number and combination of differing components as described with reference to the example device shown in FIG. 4. Portable device 102 includes an integrated touch-screen 104 to display user interfaces, user interface elements and features, user-selectable controls, selectable icons, various displayable objects, and the like. In addition, the touch-screen 104 can display various types of media content such as images, Web pages, emails, documents, spreadsheets, or other media content. Portable device 102 also includes at least a navigation input driver 106 and an interface application 108 to initiate display of a media content page 110 and various user interfaces, user interface elements, features, and controls.

In an embodiment of thumbnail image substitution, a user of portable device 102 can initiate a navigation input 112 with a touch input on the touch-screen 104 and then motion a navigation gesture 114 in a direction 116 across the touch-screen. The motion of the navigation gesture 114 is illustrated in the direction 116 as the hand moves from position 118, to position 120 (shown successively in the views). When the navigation input 112 is initiated by the user, a contact region 122 progressively expands, such as illustrated when the hand moves across the touch-screen from position 118 to position 120. The progressive expansion of the contact region 122 is then received or recognized as the navigation input 112.

The navigation input driver 106 is implemented to detect touch inputs, such as the navigation input 112 that starts on the touch-screen 104 and progresses in the direction 116 across the touch-screen. Further, the navigation input driver 106 can determine, or otherwise recognize that the expanding contact region 122 represents the navigation gesture 114 and communicate navigation input data that corresponds to the gesture to the interface application 108. Alternatively or in addition, the navigation input driver 106 can detect various navigation inputs including panning, flicking, zooming, and/or scrolling.

As illustrated, the navigation input 112 is effective to move from a first view 124 of the media content page 110 (shown in the first view) to a second view 126 of the media content page 110 (shown in the second and third views). However, the touch-screen 104 is configured to display a portion of the media content page that is less than the whole media content page, such as on a small portable device that has a smaller display screen. In this illustration, the second view 126 includes a region 128 of the media content page that is not included in the first view 124. A conventional approach to display region 128 of the media content page that is not included in the first view 124 is to display a checkerboard or grey background, which is a non-intuitive substitute for the media content that will be displayed in the second view 126 of the media content page.

The interface application 108, however, can initiate a display of a thumbnail image 130 that provides an indication of the media content that will be displayed in the region 128 of the media content page. The portable device 102 can receive and maintain the thumbnail image 130 for a region of the media content page that is likely to be displayed, or for the whole media content page. When the thumbnail image 130 is replaced to display the media content in the region 128 of the media content page 110, the thumbnail image 130 can be animated to give the appearance that the thumbnail image comes into focus when the media content is displayed clearly.

The interface application 108 can be implemented as computer-executable instructions and executed by processors to implement the various embodiments and/or features of thumbnail image substitution as described herein. In this example, the interface application 108 can display the thumbnail image 130 for the region 128 of the media content page 110 that is not included in the first view 124 when the navigation gesture 114 starts on the touch-screen 104 and progresses in the direction 116 across the touch-screen. Other navigation gestures can be recognized as panning, flicking, zooming, and/or scrolling on the touch-screen 104.

The direction in which the contact region 122 expands (e.g., direction 116 in this example) correlates to the direction of the navigation input 112. In an implementation, the navigation input driver 106 can detect the navigation input 112 from discernable variables, such as a direction variable {right-to-left}; start region position variables {left1, top1, right1, bottom1}; end region position variables {left2, top2, right2, bottom2}; and/or a motion rate variable {x number of pixels per second}. It should be noted that the representation of the navigation input 112, the indication of direction 116, and the representations of the contact region 122 are merely illustrative for discussion purposes. When embodiments of thumbnail image substitution are implemented, the various representations and indications may or may not appear on the touch-screen and/or user interface.

FIG. 2 illustrates an example system 200 in which various embodiments of thumbnail image substitution can be implemented. Example system 200 includes a portable device 202 (e.g., a wired and/or wireless device) that can be any one or combination of a mobile personal computer 204, a personal digital assistant (PDA), a mobile phone 206 (e.g., cellular, VoIP, WiFi, etc.) that is implemented for data, messaging, and/or voice communications, a portable computer device 208 (e.g., a laptop computer, a laptop computer with a touch-screen, etc.), a media device 210 (e.g., a personal media player, portable media player, etc.), a gaming device, an appliance device, an electronic device, and/or any other type of portable device that can receive, display, and/or communicate data in any form of audio, video, and/or image data.

Each of the various portable devices can include an integrated display and/or an integrated touch-screen, as well as selectable input controls via which a user can input data and/or selections. For example, mobile personal computer 204 includes an integrated touch-screen 212 on which a user interface 214 can be displayed that includes displayable objects and/or user interface elements 216, such as any type of icon, image, graphic, text, selectable button, user-selectable control, menu selection, map element, and/or any other type of user interface displayable feature or item. In addition, the user interface 214 can display various types of media content. Media content (e.g., to include recorded media content) can include any type of audio, video, and/or image data received from any media content or data source, such as messages, television media content, music, video clips, data feeds, interactive games, network-based applications, and any other content.

Any of the various portable devices described herein can be implemented with one or more sensors, processors, communication components, data inputs, memory components, storage media, processing and control circuits, and/or a content rendering system. Any of the portable devices can also be implemented for communication via communication networks that can include any type of a data network, voice network, broadcast network, an IP-based network, and/or a wireless network that facilitates data, messaging, and/or voice communications. A portable device can also be implemented with any number and combination of differing components as described with reference to the example device shown in FIG. 4. A portable device may also be associated with a user (i.e., a person) and/or an entity that operates the device such that a portable device describes logical devices that include users, software, and/or a combination of devices.

In this example, portable device 202 includes one or more processors 218 (e.g., any of microprocessors, controllers, and the like), a communication interface 220 for data, messaging, and/or voice communications, and data inputs 222 to receive media content 224. Media content (e.g., to include recorded media content) can include any type of audio, video, and/or image data received from any media content or data source, such as messages, television media content, music, video clips, data feeds, interactive games, network-based applications, and any other content. Portable device 202 is implemented with a device manager 226 that includes any one or combination of a control application, software application, signal processing and control module, code that is native to the particular device, and/or a hardware abstraction layer for the particular device.

Portable device 202 includes various software and/or media applications 228 that may incorporate components, modules, and/or interface applications 230 that can be processed or otherwise executed by the processors 218. The media applications 228 can include a music and/or video player, a Web browser, an email application, a messaging application, a photo viewer, and the like. Portable device 202 includes a rendering system 232 to render user interfaces from the interface applications 230 to generate a display on any of the portable devices. The rendering system 232 is also implemented to receive and render any form of audio, video, and/or image data received from any media content and/or data source.

Portable device 202 also includes a navigation input driver 234 and stored thumbnail images 236. A thumbnail image 236 provides an indication of media content 224 that will be displayed in a region of a particular media content page. An interface application 230 can initiate that a thumbnail image 236 be displayed via the user interface 214 and/or may cause the thumbnail image to be replaced by the corresponding media content 224. Implementations of an interface application 230 and the navigation input driver 234 are described with reference to the interface application 108 and navigation input driver 106 shown in FIG. 1, and with reference to embodiments of thumbnail image substitution as described herein.

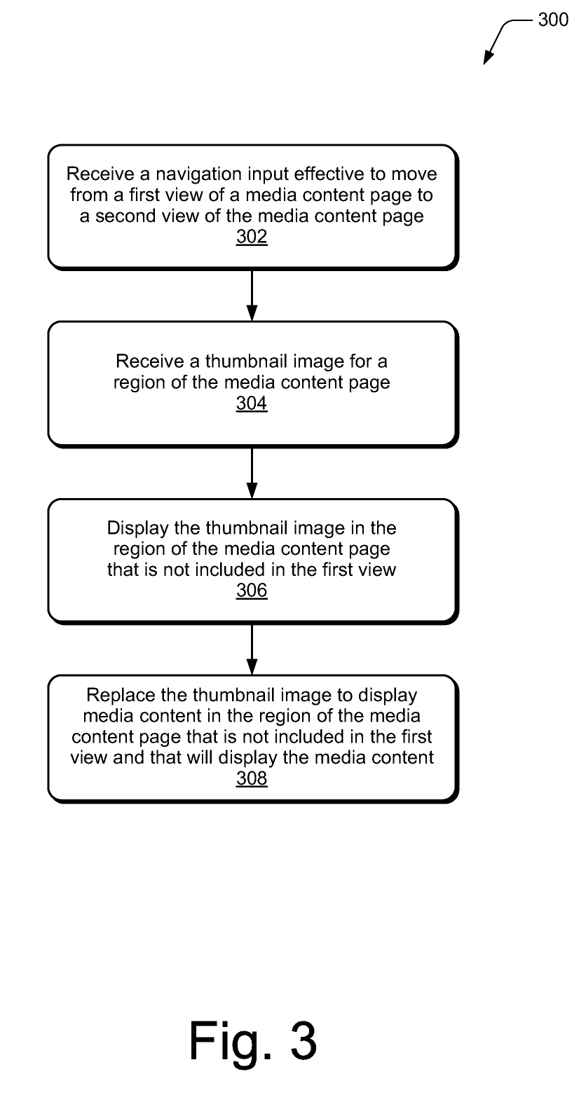

Example method 300 is described with reference to FIG. 3 in accordance with one or more embodiments of thumbnail image substitution. Generally, any of the functions, methods, procedures, components, and modules described herein can be implemented using hardware, software, firmware, fixed logic circuitry, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

FIG. 3 illustrates example method(s) 300 of thumbnail image substitution. The order in which the method blocks are described are not intended to be construed as a limitation, and any number of the described method blocks can be combined in any order to implement a method, or an alternate method.

At block 302, a navigation input is received that is effective to move from a first view of a media content page to a second view of the media content page. For example, the navigation input driver 106 of portable device 102 detects the navigation input 112 that starts at position 118 and moves in direction 116 across the touch-screen 104. The navigation input driver 106 can also detect other inputs such as panning, flicking, zooming, and/or scrolling. As illustrated, the navigation input 112 is effective to move from the first view 124 of the media content page 110 to the second view 126 of the media content page. However, the touch-screen 104 is configured to display a portion of the media content page that is less than the whole media content page. The second view 126 of the media content page 110 includes a region 128 of the media content page that is not included in the first view 124. The media content page may include various types of media content such as an image, a Web page, an email, a document, a spreadsheet, or other media content.

At block 304, a thumbnail image is received for a region of the media content page. For example, the portable device 102 receives thumbnail image 130 that the interface application 108 can display as a substitute for the region 128 of the media content page 110 that is not included in the first view 124. As depicted in FIG. 1, the thumbnail image 130 provides an indication of the media content that will be displayed in the region 128 of the media content page 110 that is not included in the first view 124. Alternatively or in addition, the thumbnail image 130 may be received and thus provide an indication of the media content for a portion of the media content page that is likely to be displayed or for the entire media content page.

At block 306, the thumbnail image is displayed in the region of the media content page that is not included in the first view and that will display the media content. For example, the interface application 108 displays the thumbnail image 130 for the region 128 of the media content page that is not included in the first view 124, but that will display the media content. The thumbnail image 130 can be displayed as a substitute for the media content in the second view 126 that is not included in the first view 124. Thus, while the portable device 102 is receiving, loading, and/or generating the media content for display, the interface application 108 can display the thumbnail image 130. Displaying the thumbnail image 130, which gives an indication of the media content that will be displayed, may provide a more user-friendly navigation experience than merely displaying a checkerboard or grey background.

At block 308, the thumbnail image is replaced to display the media content in the region of the media content page that corresponds to the second view of the media content page. For example, the interface application 108 replaces the thumbnail image 130 to display the media content for the region 128 of the media content page that is not included in the first view 124. The interface application 108 can animate the replacement of the thumbnail image 130 with the media content, and in an embodiment, the animation can give the appearance that the thumbnail image 130 comes into focus when the media content is displayed clearly.

FIG. 4 illustrates various components of an example device 400 that can be implemented as any type of portable and/or computer device as described with reference to FIGS. 1 and 2 to implement embodiments of thumbnail image substitution. Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of thumbnail image substitution. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 can include a device manager (e.g., a control application, software application, signal processing and control module, code that is native to a particular device, a hardware abstraction layer for a particular device, etc.). The device applications 418 also include any system components or modules to implement embodiments of thumbnail image substitution. In this example, the device applications 418 include an interface application 422 and a navigation input driver 424 that are shown as a software modules and/or computer applications. Alternatively or in addition, the interface application 422 and the navigation input driver 424 can be implemented as hardware, software, firmware, or any combination thereof.

Device 400 also includes an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

Although embodiments of thumbnail image substitution have been described in language specific to features and/or methods, it is to be understood that the subject of the appended claims is not necessarily limited to the specific features or methods described. Rather, the specific features and methods are disclosed as example implementations of thumbnail image substitution.

1. A computer-implemented method by a portable device, the method comprising:
receiving a navigation input effective to move from a first view of a media content page to a second view of the media content page, the second view including at least a region of the media content page that is not included in the first view;
displaying a thumbnail image in the region of the media content page that is not included in the first view and that will display media content; and
replacing the thumbnail image to display the media content in the region of the media content page that corresponds to the second view of the media content page.

2. A computer-implemented method as recited in claim 1, wherein the thumbnail image is displayed to provide an indication of the media content that will be displayed in the region of the media content page that corresponds to the second view of the media content page.

3. A computer-implemented method as recited in claim 1, further comprising displaying the first view of the media content page and the second view of the media content page separately on a display screen of the portable device, the display screen configured to display a portion of the media content page that is smaller than an entirety of the media content page.

4. A computer-implemented method as recited in claim 1, further comprising at least one of receiving the thumbnail image for a portion of the media content page that is likely to be displayed, or receiving the thumbnail image for an entirety of the media content page.

5. A computer-implemented method as recited in claim 1, further comprising animating said replacing the thumbnail image to display the media content in the region of the media content page that corresponds to the second view of the media content page.

6. A computer-implemented method as recited in claim 5, wherein said animating gives the appearance that the thumbnail image comes into focus when the media content is displayed clearly.

7. A computer-implemented method as recited in claim 1, wherein the media content page includes at least one of an image, a Web page, an email, a document, a spreadsheet, or downloaded media content.

8. A computer-implemented method as recited in claim 1, wherein the navigation input includes at least one of panning, flicking, zooming, or scrolling.

9. A portable device, comprising:
at least a memory and a processor configured to display a thumbnail image that provides an indication of media content to be displayed in a region of a media content page;
a navigation input driver configured to receive a navigation input effective to move from a first view of the media content page to a second view of the media content page, the second view including at least the region of the media content page that is not included in the first view;
an interface application configured to:
display the thumbnail image in the region of the media content page that is not included in the first view and that will display the media content; and
replace the thumbnail image to display the media content in the region of the media content page that corresponds to the second view of the media content page.

10. A portable device as recited in claim 9, wherein the interface application is further configured to display the first view of the media content page and the second view of the media content page separately on a display screen of the portable device, the display screen configured to display a portion of the media content page that is smaller than an entirety of the media content page.

11. A portable device as recited in claim 9, wherein the thumbnail image is received for at least one of a portion of the media content page that is likely to be displayed, or for an entirety of the media content page.

12. A portable device as recited in claim 9, wherein the interface application is further configured to display an animation when the thumbnail image is replaced with the media content in the region of the media content page that corresponds to the second view of the media content page.

13. A portable device as recited in claim 12, wherein the animation gives the appearance that the thumbnail image comes into focus when the media content is displayed clearly.

14. A portable device as recited in claim 9, wherein the navigation input includes at least one of panning, flicking, zooming, or scrolling.

15. Computer-readable storage media having stored thereon computer-executable instructions that, when executed by a portable device, initiate the portable device to:
receive a navigation input effective to move from a first view of a media content page to a second view of the media content page, the second view including at least a region of the media content page that is not included in the first view;
display a thumbnail image in the region of the media content page that is not included in the first view and that will display the media content; and
replace the thumbnail image to display the media content in the region of the media content page that corresponds to the second view of the media content page.

16. Computer-readable storage media as recited in claim 15, wherein the computer-executable instructions, when executed, further initiate the portable device to display the first view of the media content and the second view of the media content separately on a display screen of the portable device, the display screen configured to display a portion of the media content page that is smaller than an entirety of the media content page.

17. Computer-readable storage media as recited in claim 15, wherein the computer-executable instructions, when executed, further initiate the portable device to receive the thumbnail image for at least one of a portion of the media content that is likely to be displayed, or for an entirety of the media content page.

18. Computer-readable storage media as recited in claim 15, wherein the computer-executable instructions, when executed, further initiate the portable device to display the thumbnail image as an indication of the media content that will be displayed in the region of the media content page that corresponds to the second view of the media content page.

19. Computer-readable storage media as recited in claim 15, wherein the computer-executable instructions, when executed, further initiate the portable device to initiate an animation to replace the thumbnail image with the media content in the region of the media content page that corresponds to the second view of the media content page.

20. Computer-readable storage media as recited in claim 19, wherein the animation gives the appearance that the thumbnail image comes into focus when the media content is displayed clearly.
